(19) United States
(12) Patent Application Publication
(10) Pub. No.: US 2014/0168388 A1
(43) Pub. Date: Jun. 19, 2014

(54) SYSTEM AND METHOD FOR DISPLAYING A THREE-DIMENSIONAL IMAGE ON A VIDEO MONITOR

(71) Applicant: NVIDIA CORPORATION, Santa Clara, CA (US)

(72) Inventors: Craig Dowdall, Santa Clara, CA (US); Robert Jan Schutten, Santa Clara, CA (US); Andy Au, Santa Clara, CA (US); Gerrit Slavenburg, Santa Clara, CA (US)

(73) Assignee: NVIDIA CORPORATION, Santa Clara, CA (US)

(21) Appl. No.: 13/719,452

(22) Filed: Dec. 19, 2012

(51) Int. Cl. H04N 13/04

(52) U.S. Cl. CPC H04N 13/04
USPC 348/51

(57) ABSTRACT

A system and method are provided for display of a 3D image on a video monitor. A characteristic of each of a plurality of sample LCD panels is measured and a display parameter is calculated based on the measured characteristics. A first 3D image is displayed on one of the sample LCD panels using the calculated display parameter and the displayed image is evaluated. Based on the evaluation, each of the sample LCD panels is assigned to one of a plurality of groups. For each group, a group display parameter is calculated based on the measured characteristics of the panels assigned to the group. A video monitor controller is configured to display a second 3D image on an installation LCD panel. The second 3D image is displayed based on the group display parameters and an indication of a group to which the installation LCD panel is assigned.

### TECHNICAL FIELD

This application is directed, in general, to video monitors and, more specifically, to a system and method for displaying a three-dimensional image on a video monitor.

### BACKGROUND

Various display devices are equipped for both monoptical (i.e., “mono”) and stereoscopic (i.e., “stereo”) viewing. Unlike mono viewing, stereo viewing involves the display of separate content for the right and left human eye. Specifically, such stereo viewing requires the presentation of a left image to the left human eye and a right image to the right human eye. In one particular type of stereo viewing, namely time-sequential stereo viewing, such left and right images are presented in an alternating manner.

Numerous technologies are capable of providing such stereo viewing. For example, dual projectors provide stereo viewing with polarized light and polarized glasses. Time-sequential displays [e.g., cathode ray tube (CRT) displays, digital light processing (DLP) projectors and liquid crystal displays (LCDs)] provide stereo viewing when combined with active shutter glasses that open corresponding left and right shutters at the appropriate time.

### SUMMARY

One aspect provides a process for making a video monitor for display of a three-dimensional (3D) image. The process includes measuring a characteristic of each of a plurality of sample LCD panels and calculating a display parameter based on the measured characteristics of the plurality of sample LCD panels. The process also includes evaluating a first 3D image displayed on one of the plurality of sample LCD panels using the calculated display parameter and, based on a result of the evaluation, assigning each of the plurality of sample LCD panels to one of a plurality of groups. The process further includes, for each group of sample LCD panels, calculating a group display parameter based on the measured characteristics of the sample LCD panels assigned to the group. The process also includes configuring a video monitor controller to display a second 3D image on an installation LCD panel based on the plurality of group display parameters and an indication of a group to which the installation LCD panel is assigned.

Another aspect provides a video monitor for display of a 3D image. The video monitor includes an installation LCD panel and a video monitor controller. The video monitor controller is configured to store a plurality of display parameters associated with a corresponding plurality of groups of sample LCD panels. The sample LCD panels are assigned to groups based on a measured characteristic of the sample LCD panels. The video monitor controller is further configured to display a first 3D image on the installation LCD panel based on the plurality of display parameters and an indication of a group to which the installation LCD panel is assigned.

Yet another aspect provides an LCD panel for installation in a video monitor for display of a 3D image. The video monitor includes a video monitor controller configured to (i) store a plurality of display parameters associated with a corresponding plurality of groups of sample LCD panels and (ii) display a first 3D image on the installation LCD panel based on the plurality of display parameters and an indication of a group to which the installation LCD panel is assigned. The LCD panel includes a storage circuit and a read port. The storage circuit is configured to store an indication of a group to which the installation LCD panel is assigned. The video monitor controller reads the indication from the storage circuit via the read port.

### BRIEF DESCRIPTION

Reference is now made to the following descriptions taken in conjunction with the accompanying drawings, in which:

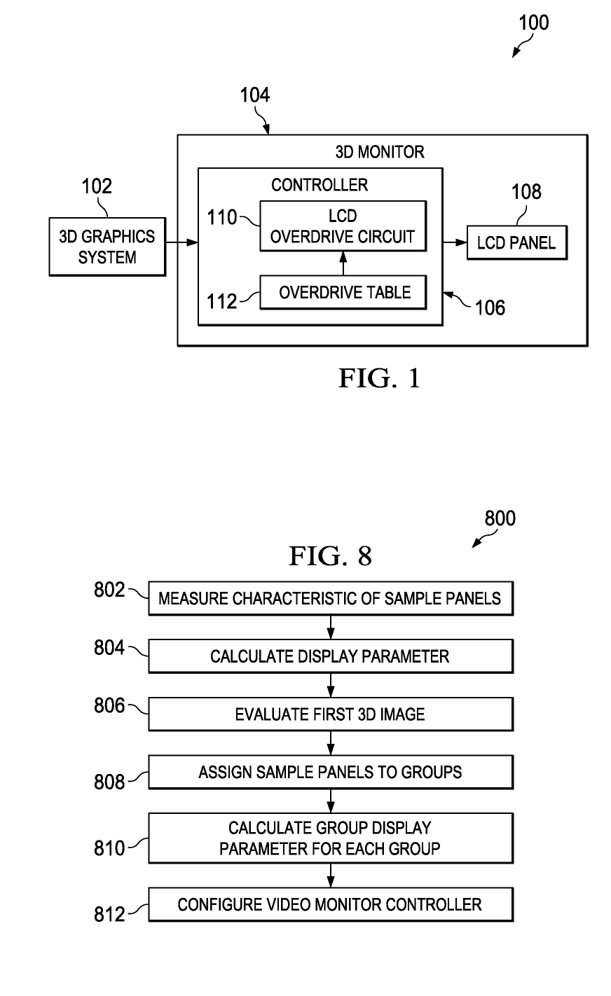

FIG. 1 is a block diagram of a 3D visualization system;

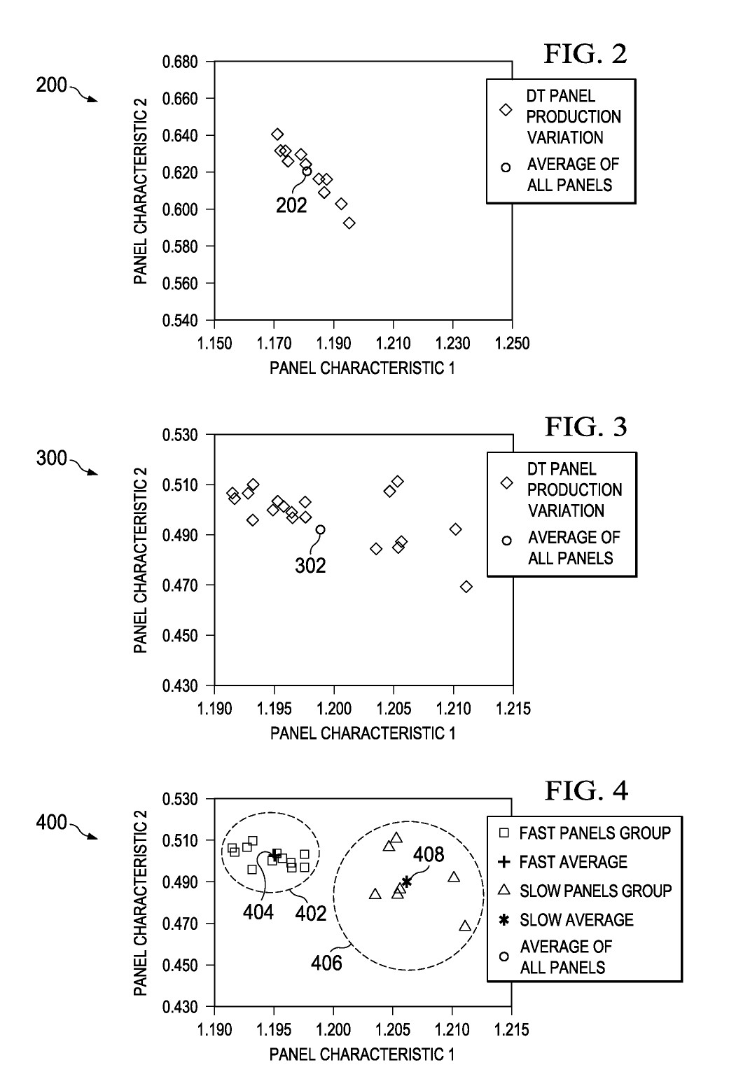

FIG. 2 is a graph showing two measured characteristics of a first plurality of sample LCD panels;

FIG. 3 is a graph showing two measured characteristics of a second plurality of sample LCD panels;

FIG. 4 is a graph according to the disclosure showing two measured characteristics of the second plurality of sample LCD panels;

FIG. 5 is a graph showing another measured characteristic of a sample LCD panel;

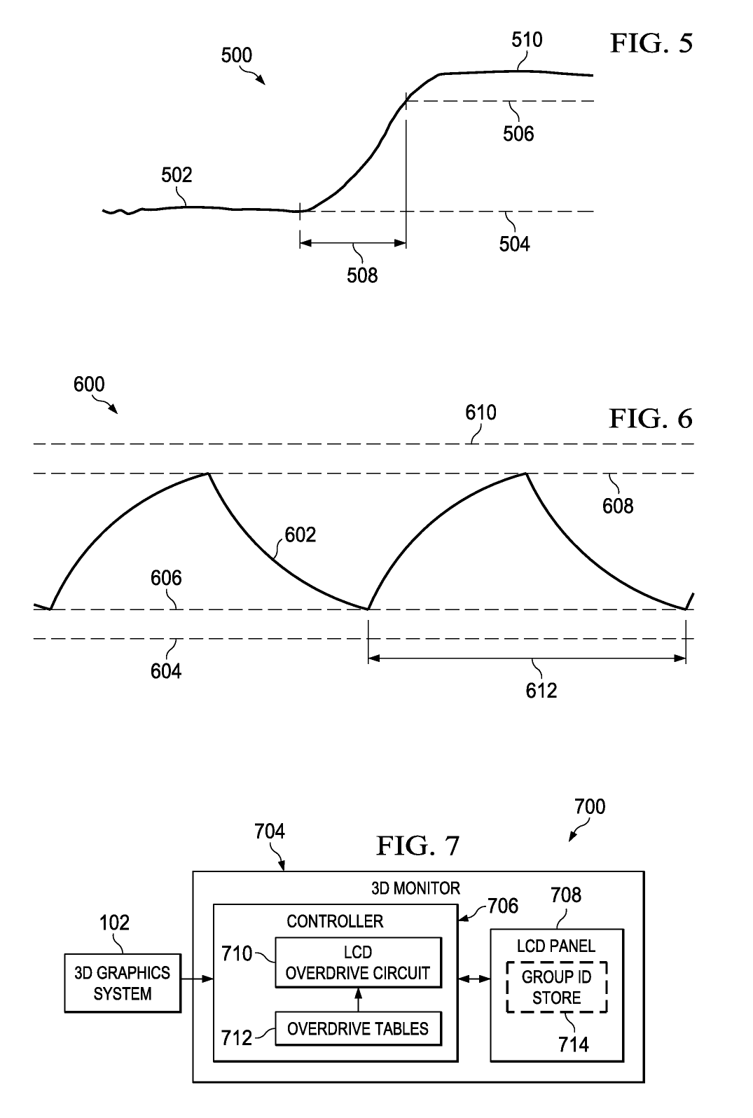

FIG. 6 is another graph showing another measured characteristic of a sample LCD panel;

FIG. 7 is a block diagram of a 3D visualization system according to the disclosure; and

FIG. 8 is a flow chart of a procedure according to the disclosure.

### DETAILED DESCRIPTION

FIG. 1 is a block diagram of a 3D visualization system 100. The system 100 includes a 3D graphics system 102 coupled to a 3D monitor 104 for display of 3D images. The monitor 104 includes a controller circuit 106 and an LCD panel 108. A manufacturer of such video monitors compensates for production variation in LCD panels and improves a quality of images displayed on the monitor 104 by including in the controller circuit 106 an LCD overdrive (OD) circuit 110 and an OD table 112 for use when displaying a 3D image on the LCD panel 108.

Display parameters stored in the OD table 112 are calculated using a plurality of sample panels of the same type as the LCD panel 108. A rising edge OD factor and a falling edge OD factor may be measured for each of the sample panels. Automated test equipment and/or an automated test routine may be used to make the measurements.

FIG. 2 is a graph 200 showing two measured characteristics of a first plurality of sample LCD panels. In the graph 200, for each LCD panel, a first measured characteristic is plotted on the horizontal axis and a second measured characteristic is plotted on the vertical axis. At least some of the variability of the first and second characteristics from panel to panel is a result of production variability.

The first and second measured characteristics are panel characteristics chosen for their utility in predicting performance of a panel in displaying a 3D image. An example of such first and second panel characteristics is described with reference to FIGS. 5 and 6.

An average value 202 of the first and second panel characteristics across the first plurality of sample LCD panels may be calculated. Referring again to FIG. 1, the OD table 112 may be generated based, in part, upon the average value 202 and used in displaying 3D images on LCD panels of the type represented by the first plurality of sample LCD panels.

FIG. 3 is a graph 300 showing two measured characteristics of a second plurality of sample LCD panels. The second plurality of LCD panels may be panels from a different manufacturer, panels of a different type, or panels of the same type but from a different manufacturing run than the panels of the first plurality of LCD panels. Similarly to the graph 200 of FIG. 2, in the graph 300, for each LCD panel, the first and second panel characteristics are plotted on the horizontal and the vertical axes, respectively. It may be seen that the second plurality of sample LCD panels has a different distribution of the first and second panel characteristics than does the first plurality of sample LCD panels. Such a distribution may indicate a clustering of panels into a plurality of groups (as shown) or may indicate a wider variation of the first and second panel characteristics than is seen in the first plurality of sample LCD panels

Similarly to the graph 200 of FIG. 2, an average value 302 of the first and second panel characteristics across the second plurality of sample LCD panels may be calculated. Referring again to FIG. 1, the OD table 112 may be generated based, in part, upon the average value 302.

However, 3D images displayed on certain ones of the second plurality of sample LCD panels may exhibit larger amounts of 3D measurement error and visual ghosting, crosstalk, and/or other artifacts. Typically, such 3D image degradation will be exhibited on LCD panels whose measured first and second panel characteristics are the farthest from the calculated average value 302.

FIG. 4 is a graph 400 according to the disclosure showing two measured characteristics of the second plurality of sample LCD panels. The second plurality of LCD panels have each been assigned to one of two groups, based on their relative speed. A group 402 may be described as comprising “fast” panels, while a group 406 may be described as comprising “slow” panels. A “fast” average value 404 may be calculated for the “fast” group 402, and a “slow” average value 408 may be calculated for the “slow” group 406.

As will be described in greater detail with reference to FIG. 7, in a system according to the disclosure, a “fast” OD table may be generated based, in part, upon the “fast” average value 404 and a “slow” OD table may be generated based, in part, upon the “slow” average value 408. A video monitor according to the disclosure that has installed in it an LCD panel of the same type as the second plurality of sample LCD panels may then display 3D images on the installed LCD panel based on an indication of whether the installed LCD panel has been assigned to the “fast” group 402 or the “slow” group 406 and an associated one of the “fast” OD table and the “slow” OD table.

While the present disclosure describes embodiments assigning LCD panels to two groups—“fast” and “slow”—it will be understood that in other embodiments, any suitable number of groups may be used, to achieve a desired level of 3D image quality across substantially all LCD panels of a particular type. Similarly, still other embodiments may store OD tables for LCD panels of more than one type, to achieve a desired level of 3D image quality across substantially all LCD panels of more than one type.

FIG. 5 is a graph 500 showing another measured characteristic of a sample LCD panel. The graph 500 plots a luminance level 502 of an LCD panel over time. Specifically, prior to the beginning of the time period 508 a first video frame having a first brightness value is displayed on the LCD panel. At the beginning of the time period 508, a second video frame having a second brightness level of higher value is displayed on the LCD panel.

At the beginning of the time period 508, the LCD panel has a corresponding first luminance level 504. At the end of the time period 508, the LCD panel has a corresponding second luminance level 506. The time period 508 is preferably one frame time, which is typically 8.3 milliseconds for a 120 Hertz (Hz) refresh rate. Using this technique, the measured characteristic of the LCD panel is the luminance level 506, expressed as a percentage of a steady state, long term luminance level 510 that is achieved by the LCD panel when displaying the second brightness level for an extended period of time.

FIG. 6 is a graph 600 showing another measured characteristic of a sample LCD panel. The graph 600 includes a trace 602 of a luminance level of an LCD panel having displayed on it alternating first and second video frames. The first frame has a lower brightness value, while the second frame has a higher brightness value.

It may be seen that over a time period 612—equal to two frame times—a luminance level of the LCD panel rises to from a first value 606 to a second value 608, then falls back to the first value 606. A value 604 represents a luminance level that would be achieved if continually displaying the frame with the lower brightness value. A value 610 represents a luminance level that would be achieved if continually displaying the frame with the higher brightness value. Using this technique, the measured characteristic of the LCD panel is the difference in the luminance levels 606 and 608. The measured characteristic is expressed as a percentage of the luminance levels 604 and 610 that are achieved as steady state values for the first and second brightness levels.

In some embodiments, the first and second panel characteristics described with reference to FIGS. 2-4 may be measured characteristics derived from the measured values of FIG. 6. The first characteristic may be the luminance level 606, expressed as a percentage of the luminance levels 604 and 610, while the second characteristic may be the luminance level 608, expressed as a percentage of the luminance levels 604 and 610. In various embodiments, LCD panels may be assigned based upon one or more of the measured characteristics of the luminance level 506 of FIG. 5 or the luminance levels 606 and 608 of FIG. 6.

In some embodiments, during a design phase of manufacturing, a first set of panel characteristics measured from sample LCD panels may be used in identifying two or more groups of panels having differing 3D image quality performance. Then, during a production phase of manufacturing, a second set of panel characteristics measured from installation LCD panels may be used to select from a corresponding group of two or more OD tables to use in displaying 3D images on the installation LCD panels.

Where one or more steps of a procedure according to the disclosure are performed by a third party, having that party make measurements as described with reference to FIG. 5 and FIG. 6 may allow the techniques of the disclosure to be used while protecting proprietary information that might otherwise be revealed. Such proprietary information may relate to the panel characteristics measured and calculations performed in identifying two or more groups of LCD panels and calculating OD tables for use in displaying 3D images on the panels.

FIG. 7 is a block diagram of a 3D visualization system 700 according to the disclosure. The system 700 includes a 3D graphics system 102 coupled to a 3D monitor 704 for display of 3D images. The monitor 704 includes a controller circuit 706 and an LCD panel 708.

The controller circuit 706 includes an LCD overdrive circuit 710 and a plurality of OD tables 712, calculated using the techniques generally described with reference to FIGS. 4-6 and described in greater detail below with reference to FIG. 8. The controller 706 displays 3D images on the LCD panel 708 based upon an indication of a group to which the LCD panel 708 has been assigned. Specifically, the controller 706 selects an OD table from the plurality of OD tables 712 based upon the indication and displays 3D images on the LCD panel 708 via the LCD overdrive circuit 710 using the selected OD table.

In some embodiments, the indication of the group to which the LCD panel 708 has been assigned is stored in a group ID storage circuit 714 of the LCD panel 708. Such storage may be performed by a manufacturer of the LCD panel, before the LCD panel is shipped to a monitor assembler. The controller circuit 706 is configured to read the group ID storage circuit 714 via a read port (not shown in FIG. 7) of the LCD panel 708.

In some such embodiments, the group ID storage circuit 714 comprises a pattern of one or more resistor pull-ups and pull-downs (also known as strapping resistors). In other such embodiments, the group ID storage circuit 714 comprises electrically erasable programmable read-only memory (EEPROM) or other suitable semiconductor memory. In still other such embodiments, any other suitable storage may be used.

In other embodiments, the indication of the group to which the LCD panel 708 has been assigned is stored in memory accessible to the controller circuit 706. In some such embodiments, a technician or other user who is assembling the monitor 704 may measure one or more characteristics of the LCD panel 708 using one of the techniques described with reference to FIGS. 4-6. The technique used by the technician to measure the characteristic(s) may be the same as, or different than, the technique used to calculate the OD tables 712. Based upon the measured characteristic(s), the user assigns the LCD panel 708 to a group and then uses a menu system of the controller circuit 706 to store the indication of the group to which the LCD panel 708 has been assigned.

In other such embodiments, a technician or other user may display one or more 3D images on the LCD panel 708 using a default one of the plurality of OD tables 712. The user then evaluates the displayed 3D image(s) and determines whether the LCD panel 708 should be assigned to a different group than the group associated with the default OD table. The 3D image(s) may be selected or designed such that one or more visual characteristics of the displayed image provide the user with guidance as to the group to which the LCD panel 708 should be assigned.

Once the user has determined the proper group for the LCD panel 708, the user assigns the LCD panel 708 to the group and then uses a menu system of the controller circuit 706 to store the indication of the group to which the LCD panel 708 has been assigned. It will be understood that, in embodiments where a menu system of the controller 706 is used to store the group indication, the user may interface with the menu system via the LCD panel 708 or via a service port (not shown in FIG. 7) of the controller 706.

FIG. 8 is a flow chart of a procedure 800 according to the disclosure. In step 802, one or more characteristics of each of a plurality of sample panels in measured. In step 804, a display parameter is calculated based upon the measured characteristics of the plurality of panels. In some embodiments, the display parameter is calculated based upon an aggregate value (such as, but not limited to, an average value) that is calculated from the measured characteristics of the plurality of panels. In some embodiments, the display parameter is an LCD overdrive table.

In step 806, a first 3D image is displayed on one or more selected sample panels using the display parameter calculated in step 804. In some embodiments, the one or more panels are selected based upon a comparison of the measured characteristic(s) of the selected panels to the aggregate value calculated in step 804. In such embodiments, those panels having a greatest difference in value between their measured characteristic and the aggregate value may be selected.

An evaluation is made of one or more characteristics (or qualities) of the first 3D image as displayed on the one or more selected LCD panels. Based upon a result of the evaluation, a decision may be made to assign the plurality of sample LCD panels to two or more groups. In step 808, each of the plurality of sample LCD panels is assigned to one of one or more groups.

In some embodiments, such assignment is made by visually examining a graph such as the graph shown in FIG. 4 and forming two or more groups based upon a visually evaluated proximity of plotted values. In other embodiments, such assignment is made through the use of a heuristic method in which potential groupings of LCD panels are formed and a variability among the measured characteristic(s) of the potential group is compared against threshold maximum allowable variability to determine whether to accept or discard the potential group.

In step 810, a group display parameter is calculated for each group based on the measured characteristic(s) of the sample LCD panels assigned to the group. In some embodiments, the display parameter is calculated based upon an aggregate value calculated from the measured characteristic(s) of the panels assigned to the group. In some embodiments, the display parameter for each group is an LCD overdrive table. In other embodiments, the display parameter for each group includes additional or alternate parameters affecting the quality of a 3D image displayed on the panel.

In step 812, a video monitor controller circuit is configured to display one or more 3D images on LCD panels of a type represented by the sample LCD panels, where the LCD panels are installed in video monitors having the video monitor controller circuit. The controller circuit is configured to display the 3D images based upon the group display parameters calculated in step 810 and an indication of a group to which the installation LCD panel has been assigned.

Those skilled in the art to which this application relates will appreciate that other and further additions, deletions, substitutions and modifications may be made to the described embodiments. cm What is claimed is:

1. A process for making a video monitor for display of a three-dimensional (3D) image, comprising:
measuring a characteristic of each of a plurality of sample LCD panels;
calculating a display parameter based on the measured characteristics of the plurality of sample LCD panels;
evaluating a first 3D image displayed on one of the plurality of sample LCD panels using the calculated display parameter;
based on a result of the evaluation, assigning each of the plurality of sample LCD panels to one of a plurality of groups;
for each group of sample LCD panels, calculating a group display parameter based on the measured characteristics of the sample LCD panels assigned to the group; and
configuring a video monitor controller to display a second 3D image on an installation LCD panel based on the plurality of group display parameters and an indication of a group to which the installation LCD panel is assigned.

2. The process as recited in claim 1 wherein an identifier of the group to which the installation LCD panel is assigned is stored in the installation LCD panel and the video monitor controller displays the second 3D image based on the stored identifier.

3. The process as recited in claim 1 wherein the indication of a group to which the installation LCD panel is assigned is based on evaluating a third 3D image displayed on the installation LCD panel.

4. The process as recited in claim 1 wherein the indication of a group to which the installation LCD panel is assigned is based on measuring the characteristic of the installation LCD panel.

5. The process as recited in claim 1 wherein the first 3D image is displayed on an LCD panel that is selected based upon a comparison of a calculated aggregate value to the measured characteristic of the selected LCD panel.

6. The process as recited in claim 1 wherein measuring a characteristic of each of a plurality of sample LCD panels comprises measuring a rising edge overdrive factor and a falling edge overdrive factor for each of the plurality of sample LCD panels.

7. The process as recited in claim 1 wherein measuring a characteristic of each of a plurality of sample LCD panels comprises measuring a change in a luminance level of the sample LCD panel between a first video frame having a first brightness value and a succeeding video frame having a second brightness value.

8. The process as recited in claim 1 wherein measuring a characteristic of each of a plurality of sample LCD panels comprises:
displaying alternating video frames having first and second brightness levels, respectively, where the first brightness level is lower than the second brightness level; and
measuring a difference between a lowest luminance level of the sample LCD panel while displaying the first frame and a highest luminance level of the sample LCD panel while displaying the second frame.

9. A video monitor for display of a three-dimensional (3D) image, the video monitor comprising:
an installation LCD panel; and
a video monitor controller configured to:
store a plurality of display parameters associated with a corresponding plurality of groups of sample LCD panels, wherein the sample LCD panels are assigned to groups based on a measured characteristic of the sample LCD panels, and
display a first 3D image on the installation LCD panel based on the plurality of display parameters and an indication of a group to which the installation LCD panel is assigned.

10. The 3D video monitor as recited in claim 9 wherein the indication of a group to which the installation LCD panel is assigned comprises an identifier of the assigned group stored in the installation LCD panel and the video monitor controller displays the first 3D image based on the stored identifier.

11. The 3D video monitor as recited in claim 10 wherein the identifier is stored in the installation LCD panel in one of: a semiconductor memory, and one or more strapping resistors.

12. The 3D video monitor as recited in claim 9 wherein the indication of a group to which the installation LCD panel is assigned is based on evaluating a second 3D image displayed on the installation LCD panel.

13. The 3D video monitor as recited in claim 12 wherein the indication is stored in a memory of the video monitor controller.

14. The 3D video monitor as recited in claim 9 wherein the video monitor controller comprises an LCD overdrive circuit and the plurality of display parameters comprise a corresponding plurality of overdrive tables.

15. The 3D video monitor as recited in claim 14 wherein the video monitor controller is further configured to select an overdrive table based on the indication of a group to which the installation LCD panel is assigned.

16. An LCD panel for installation in a video monitor for display of a three-dimensional (3D) image, the video monitor comprising a video monitor controller configured to (i) store a plurality of display parameters associated with a corresponding plurality of groups of sample LCD panels and (ii) display a first 3D image on the installation LCD panel based on the plurality of display parameters and an indication of a group to which the installation LCD panel is assigned, the LCD panel comprising:
a storage circuit configured to store an indication of a group to which the installation LCD panel is assigned; and
a read port whereby the video monitor controller reads the indication from the storage circuit.

17. The LCD panel as recited in claim 16 wherein the stored indication comprises an identifier of the group to which the installation LCD panel is assigned.

18. The LCD panel as recited in claim 16 wherein the storage circuit comprises one of a semiconductor memory and one or more strapping resistors.

19. The LCD panel as recited in claim 16 wherein the stored indication is based on a measured characteristic of the installation LCD panel.

20. The LCD panel as recited in claim 19 wherein the measured characteristic is one of:
(i) a rising edge overdrive factor and a falling edge overdrive factor, and
(ii) a change in a luminance level of the installation LCD panel between a first video frame having a first brightness value and a succeeding video frame having a second brightness value.
